(19) United States
(12) Patent Application Publication
(10) Pub. No.: US 2003/0215169 A1
(43) Pub. Date: Nov. 20, 2003

(54) Rolling bearing

(75) Inventor: Hiroyuki Yajima, Kitasaku-gun (JP)

Correspondence Address: OLIFF & BERRIDGE, PLC, P.O. BOX 19928, ALEXANDRIA, VA, 22320, US

(73) Assignee: Minebea Co., Ltd., Kitasaku-gun (JP)

(21) Appl. No.: 10/430,407

(22) Filed: May 7, 2003

Related U.S. Application Data
(63) Continuation of application No. 09/711,943, filed on Nov. 15, 2000, now abandoned.

(30) Foreign Application Priority Data
Oct. 22, 1999 (JP) 11-300940

(51) Int. Cl. F16C 33/58

(52) U.S. Cl. 384/516

(57) ABSTRACT

The surface roughness of the track surface 2 of the inner race 1 and the track surface 4 of the outer race 3 is made to be less than 18 nmRₐ preferably less than 10 nmRₐ, the progress of surface coarsening is to be eliminated by making the ball 5 roll smoothly to prevent the rotation vibration and the rotation noise occurring thereof.

This is a Continuation of application Ser. No. 09/711,943 filed Nov. 15, 2000. The entire disclosure of the prior application is hereby incorporated by reference herein in its entirety.

### BACKGROUND OF THE INVENTION

1. Field of the Invention

This invention relates to a rolling bearing such as a ball bearing and roller bearing, in particular, suitable for application requiring low vibration and low noise.

2. Conventional Art

For instance, in a hard disk drive, a rotation vibration occurring at a bearing portion for supporting a swing arm and at the bearing portion of a spindle motor, and a rotation noise caused by this vibration has been a problem. This rotation vibration occurs in relation with a variety of elements such as the surface roughness of track surfaces of inner and outer races, the roundness of the track surface, precision of rolling element, lubrication and pressurization, and therefore, conventionally, standards of every element mentioned above are determined and quality control has been carried out in such a manner to make every element meet requirements specified in its related standard.

Now, the above rotation vibration was found to be increased by long time usage, and it has been assumed that one of the reasons for this incidence is a surface coarsening of the inner and outer races track surface. This coarsening of the track surface is caused by the repeated rolling attack of the rolling body against the track surface, and therefore, it is quite important to eliminate that surface coarsening for securing low vibration and low noise.

However, at present no effective countermeasure has been found to hold up the coarsening of the aforementioned inner and outer races, and accordingly, it has not been possible to respond to the increasing customer's demand concerning vibration and noise.

The present invention has been made in the background of the above circumstance, and an object thereof is to provide a rolling bearing on which coarsening in the course of time is preferably eliminated, thereby enabling to maintain low vibration and low noise constantly for a long period of time.

After a profound discussion for countermeasures concerning the aforementioned coarsening, inventors involved in the present invention found out that there is a close relation between the initial surface roughness of the inner and outer race track surface and the coarsening in the course of time and it was discovered that by maintaining the track initial surface roughness below a given value, it became possible to eliminate coarsening in the course of time.

That is, that the present invention is characterized in that the track surfaces of the inner and outer race has been made less than 18 nmRa, preferably less than 10 nmRa by the manufacturing process.

The surface coarsening of the track surfaces of the inner and outer races in the conventional rolling bearing is in general 100-300 nmRₐ, even at the finest to the extent of 50 nmRₐ, and comparing with the surface roughness of the track surfaces in the above conventional rolling bearing the surface roughness of the track surface in the present invention is outstandingly fine. And, by making the surface roughness of the inner and outer races fine, the rolling of the rolling element becomes smooth, and the coarsening in the course of time is outstandingly eliminated. In this case, the lower the roughness of the track surface is maintained, all the more the coarsening can be eliminated, however, since the effect of the coarsening elimination relating the surface roughness will be almost saturated at less than 10 nmRa, the lower limit of the surface roughness shall be optical considering productivity and cost etc.

The present invention does not limit the type of material to be used for inner and outer ring, but more effectiveness can be realized on rolling bearings made of steel material, since coarsening occurs more easily when inner and outer ring made of steel material is used. For a kind of steel in this case, not only a high carbon chrome steel (bearing steel) which is commonly used but also a stainless steel is mentioned.

### BRIEF EXPLANATION OF THE DRAWINGS

FIG. 1 is a sectional view of the structure of the ball bearing as one embodiment of the present invention.

FIG. 2 is a graph showing an influence of the oscillation cycle and the surface roughness of the track to a variation of the rotation torque in an oscillation test.

FIG. 3 is a graph showing an influence of the surface roughness of the track to a variation ratio of the rotation torque in an oscillation test.

FIG. 4 is an oscillograph of the rotation torque of the bearing including the scope of the present invention.

FIG. 5 is an oscillograph of the rotation torque of the bearing including the scope of the present invention.

FIG. 6 is an oscillograph of the rotation torque of the bearing out of scope of the present invention.

### EMBODIMENT

Hereinafter, one embodiment of the present invention is explained.

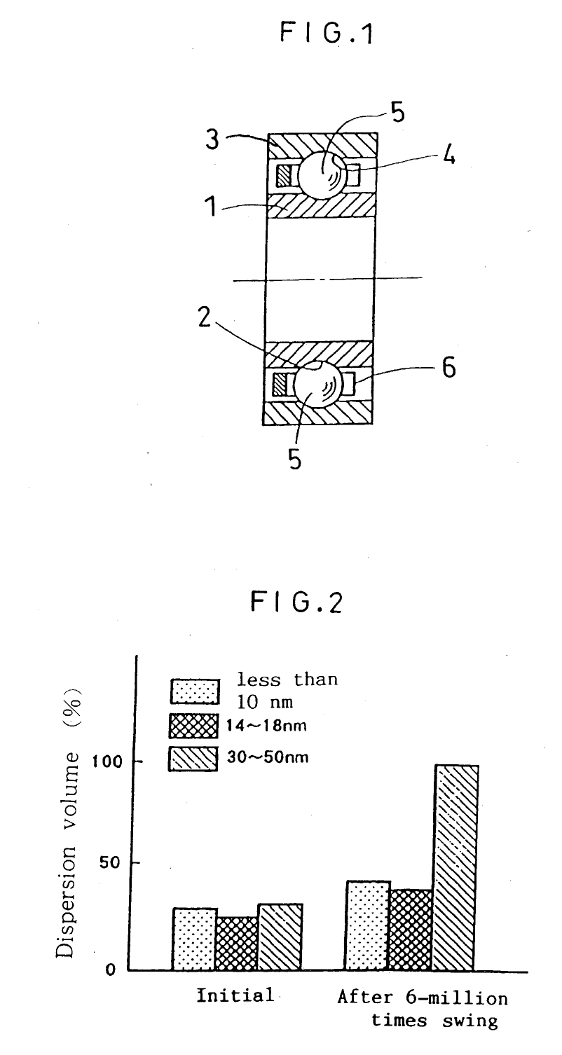

FIG. 1 shows a ball bearing as one embodiment of a rolling bearing relating to the present invention. The whole structure of the ball bearing is not different in particular from a steel ball bearing which is commonly used, in which a plurality of balls (rolling elements) 5 are interposed between the track surface 2 of the inner race 1 and the track surface 4 of the outer race 3, and said balls 5 are retained in the retainer 6 at an equal spacing in the circular direction. Thus, in the present embodiment, the track surface 2 of the inner race 1 and the track surface 4 of the outer race 3 are superfinished by a grinding process to achieve a surface of less than 18 nmRa, preferably less than 10 nmRa. Such a superfinish can be achieved by pushing a grind stone with extremely fine grain size and relatively low grade against the track surface and proceeding 2nd and 3rd grinding processes, replacing the grinding stone, a track surface roughness of not exceeding the upper limit, (less than 18 nmRa) can be secured more certainly.

By fining the surface roughness of the track surface 2 of the inner race 1 and the track surface 4 of the outer race 3, the rolling of the balls 5 becomes smooth, and the coarsening of the track surfaces 2 and 4 in the course of time is eliminated, and as a result, the increase of the rotation vibration and the rotation noise caused by the rotation vibration is eliminated, and for instance it is suitable to apply to the bearing portion of a swing arm in a hard disk drive or bearing portion of a spindle motor in a hard disk drive.

Test Example

Steel made standard bearings DDRI-6 1 4 Z Z B5 6MTH, ASP58L and Y255L were provided to be used as test specimen; the track surface of inner and outer rings were superfinished at different values of surface roughness and test specimen were divided into 3 groups which are, surface roughness less than 10 nmRa, 14 to 18 nmRa and 30 to 50 nmRa. The bearings were mounted into the bearing portion of the swing arm for a hard disk drive, filled with grease and then subjected to an oscillation test at 10 Hz×6,000,000 cycles. Rotating torque values of test specimen belonging to each groups were measured at the initial stage and at the final stage of the test.

Tables 1 to 3 show the results of the oscillation tests, and Table 1 represents the group of the surface roughness of less than 10 nmRₐ, Table 2 represents the group of the surface roughness of 14 to 18 nmRₐ and Table 3 represents a group of the surface roughness of 30 to 50 nmRₐ. Furthermore, in each Table, deviation values c, g indicate the deviation value between maximum values a and e, and minimum values b and f (c=a−b, e−f), variation A, B indicate the ratio of the deviation value c to average values d, h, variation ratio indicates a ratio (B/A) of the variation B to the variation A of the initial rotation torque after 6,000,000 test cycles.

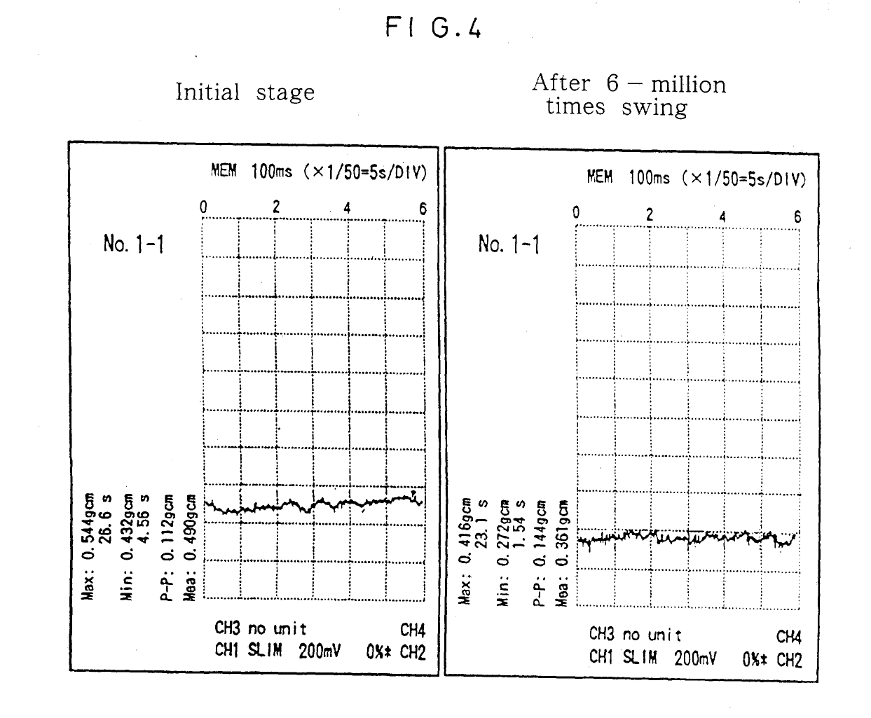

Furthermore, the average values of the above variation A, B and of the variation ratio (B/A) are indicated in FIG. 4 in the gross by selecting from FIGS. 1 to 3, and by arranging the data of FIG. 4 in another manner an influence of the oscillating time on the variation and an influence of the surface roughness on the variation ratio are indicated in FIG. 1 and FIG. 2 respectively.

TABLE 1

| | Initial rotation torque | | | | | Rotatiom torque after 6 million times | | | | | |
|---|---|---|---|---|---|---|---|---|---|---|---|
| | (×0.000098N · m) | | | | | (×0.000098 N · m) | | | | | Dispersion |
| | maximum | minimum | difference | average | dispersion | maximum | minimum | difference | average | dispersion | volume |
| | value | value | value | value | volume | value | Value | value | value | value | ratio |
| No. | a | b | c = a − b | d | A = c/d (%) | e | f | g = e − f | h | B = g/h (%) | B/A (%) |
| 1-1 | 0.544 | 0.432 | 0.112 | 0.490 | 22.8 | 0.416 | 0.272 | 0.144 | 0.861 | 39.9 | 175 |
| 1-2 | 0.664 | 0.472 | 0.192 | 0.586 | 32.8 | 0.512 | 0.386 | 0.176 | 0.488 | 40.1 | 122 |
| 1-3 | 0.604 | 0.352 | 0.152 | 0.485 | 34.9 | 0.844 | 0.240 | 0.104 | 0.285 | 38.5 | 105 |
| 1-4 | 0.616 | 0.160 | 0.160 | 0.540 | 29.0 | 0.464 | 0.280 | 0.184 | 0.888 | 47.4 | 162 |
| average | 0.603 | 0.428 | 0.154 | 0.512 | 30.0 | 0.434 | 0.282 | 0.288 | 0.361 | 42.0 | 140 |
| value | | | | | | | | | | | |

TABLE 2

| | Initial rotation torque | | | | | Rotatiom torque after 6 million times | | | | | |
|---|---|---|---|---|---|---|---|---|---|---|---|
| | (×0.000098N · m | | | | | ×0.000098 N · m | | | | | Dispersion |
| | maximum | minimum | difference | average | dispersion | maximum | minimum | dispersion | average | dispersion | volume |
| | value | value | value | value | volume | value | value | value | value | volume | ratio |
| No. | a | b | c = a − b | d | A = c/d (%) | e | f | g = e − f | h | B = g/h (%) | B/A (%) |
| 2-1 | 0.892 | 0.280 | 0.112 | 0.335 | 33.4 | 0.456 | 0.288 | 0.168 | 0.882 | 48.9 | 181 |
| 2-2 | 0.400 | 0.312 | 0.088 | 0.345 | 25.5 | 0.472 | 0.320 | 0.152 | 0.405 | 37.5 | 147 |
| 2-3 | 0.472 | 0.392 | 0.080 | 0.425 | 18.8 | 0.448 | 0.328 | 0.120 | 0.897 | 80.2 | 161 |
| 2-4 | 0.466 | 0.344 | 0.112 | 0.418 | 27.1 | 0.448 | 0.312 | 0.186 | 0.383 | 35.5 | 181 |
| average | 0.430 | 0.382 | 0.098 | 0.380 | 25.8 | 0.456 | 0.312 | 0.144 | 0.392 | 86.7 | 142 |
| value | | | | | | | | | | | |

TABLE 3

| | Initial rotation torque | | | | | Rotatiom torque after 6 million times | | | | | |
|---|---|---|---|---|---|---|---|---|---|---|---|
| | (×0.000098N · m) | | | | | (×0.000098 N · m) | | | | | Dispersion |
| | maximum | minimum | difference | average | dispersion | maximum | minimum | difference | average | dispersion | volume |
| | value | value | value | value | volume | value | value | value | value | volume | ratio |
| No. | a | b | c = a − b | d | A = c/d (&) | e | f | g = e − f | h | B = g/h (%) | B/A (%) |
| 3-1 | 0.416 | 0.304 | 0.112 | 0.862 | 30.9 | 0.812 | 0.208 | 0.104 | 0.260 | 40.0 | 129 |
| 3-2 | 0.624 | 0.488 | 0.186 | 0.548 | 24.8 | 0.704 | 0.448 | 0.256 | 0.557 | 46.0 | 185 |
| 3-3 | 0.576 | 0.456 | 0.120 | 0.503 | 23.8 | 0.832 | 0.176 | 0.456 | 0.424 | 107.5 | 452 |
| 3-4 | 0.792 | 0.576 | 0.218 | 0.688 | 31.4 | 0.816 | 0.272 | 0.544 | 0.550 | 98.9 | 315 |
| 3-5 | 0.512 | 0.352 | 0.160 | 0.426 | 37.6 | 0.672 | 0.200 | 0.472 | 0.414 | 114.0 | 303 |
| 3-6 | 0.680 | 0.472 | 0.208 | 0.564 | 36.9 | 0.632 | 0.304 | 0.828 | 0.433 | 75.7 | 204 |
| 3-7 | 0.648 | 0.440 | 0.208 | 0.546 | 38.0 | 0.586 | 0.144 | 0.392 | 0.850 | 112.0 | 294 |
| 3-8 | 0.640 | 0.480 | 0.160 | 0.575 | 27.8 | 0.944 | 0.256 | 0.688 | 0.544 | 126.4 | 454 |
| 3-9 | 0.632 | 0.424 | 0.208 | 0.522 | 39.9 | 0.912 | 0.208 | 0.704 | 0.505 | 139.4 | 349 |
| average | 0.613 | 0.443 | 0.170 | 0.526 | 32.3 | 0.684 | 0.246 | 0.395 | 0.405 | 98.0 | 303 |
| value | | | | | | | | | | | |

TABLE 4

Dispersion volume of
rotation torque (%)

| Surface | | after 6 | Dispersion |
|---|---|---|---|
| roughness | initial | million | volume ratio |
| group | value | times | B/A |
| (nm) | A | B | (%) |
| 20 Ra | 30.0 | 42.0 | 140 |
| 14˜18 Ra | 25.8 | 36.7 | 142 |
| 30˜50 Ra | 32.3 | 98.0 | 303 |

From the results of Tables 1 to 4 and FIGS. 1, 2, if estimating them as an average value of the rotation torque, both at the initial stage and after 6,000,000 cycles of oscillation, the difference between the groups of different surface roughness is not so large, by which little influence due to the surface roughness is recognized. Furthermore, similarly, considering as an average value of the rotation torque, comparing at the initial stage with after 6,000,000 cycles of oscillation, an average value of the latter becomes rather small. By this, it is presumed that the grease lubrication was infiltrated in accordance with the progress of the oscillation.

On the other hand, referring to the variation and the variation ratio, of the rotation torque, although, at the initial stage the difference due to the groups in the surface roughness is not recognized, after 6,000,000 cycles of oscillation the variation and the variation ratio of 30 to 50 nmRₐ group becomes outstandingly large comparing with the one of the groups of less than 10 nmRₐ and 14 to 18 nmRₐ.

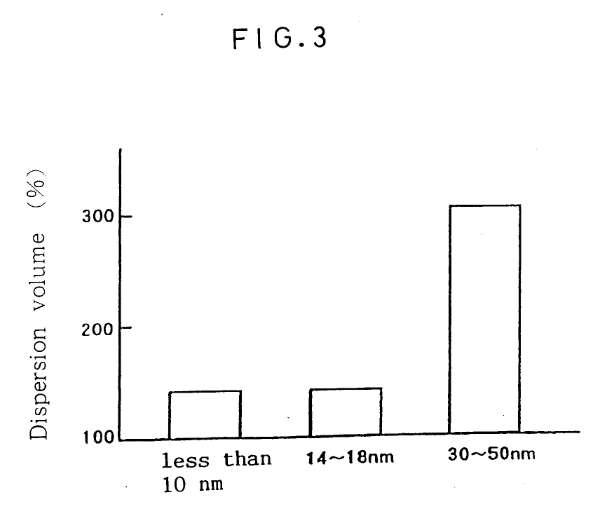

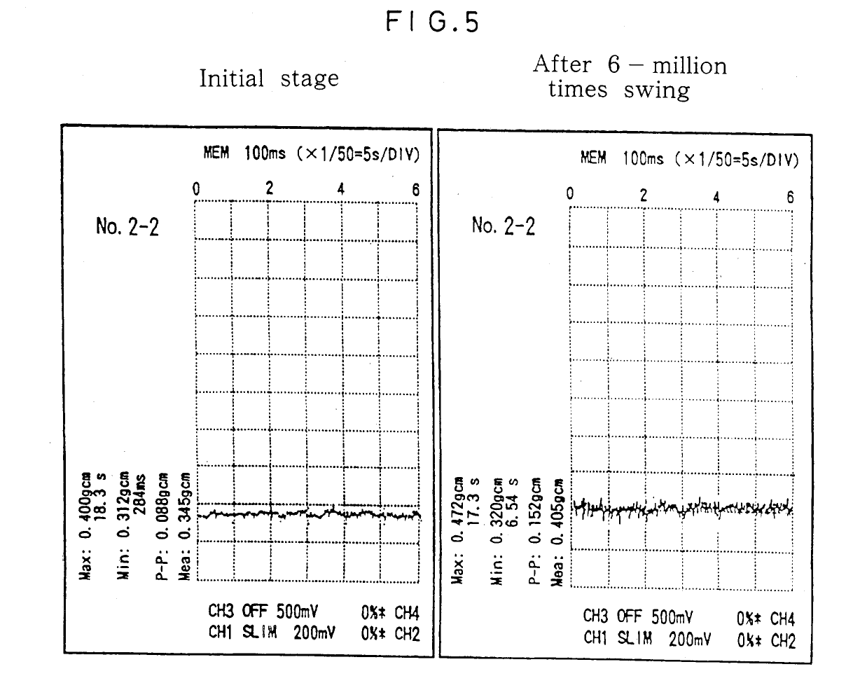

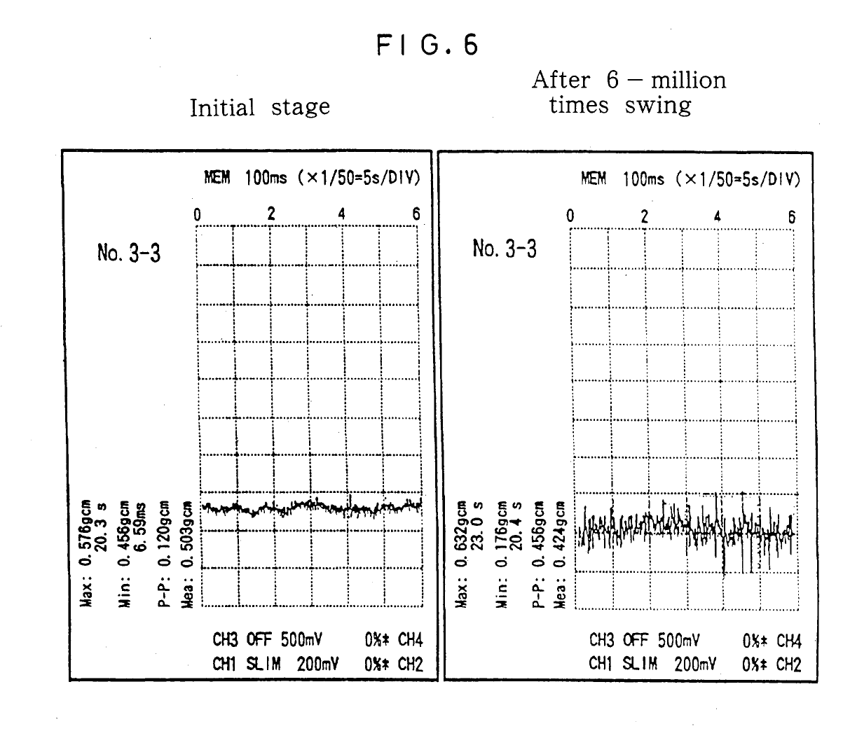

FIGS. 3 to 5 show oscillographs of the sample No. 1-1, 2-2 and 3-3 extracted from the groups of less than 10 nmRₐ, 14 to 18 nmRₐ group and 30 to 50 nmRₐ, and from these oscillographs too, the amplitude (variation) of the rotation torque of the 30 to 50 nmRₐ group is recognized to be outstandingly large comparing with the groups of less than 10 nmRₐ and 14 to 18 nmRₐ.

This variation of the rotation torque relates to the surface roughness of the track surfaces of the inner and outer races, and the increase of the variation and the variation ratio in the group of the above 30 to 50 nmRₐ means that the coarsening of the track surface is progressing outstandingly. And, this surface coarsening causes to increase of the rotation vibration and the noise derived therefrom, and from the result of the aforementioned oscillation test, it is recognized as preferable to make the roughness of the track surface of the inner and outer races less than 18 nmRₐ for safety's sake less than 10 nmRₐ, in order to eliminate the occurrence of the rotation vibration to prevent the occurrence of noise even after use for a long period of time.

As explained above, according to the rolling bearing of the present invention, the coarsening of the track surface of the inner and outer ring in the course of time can be preferably eliminated, which means that low vibration and low noise can be maintained constantly for a long period of time, contributing to a suitable application on equipment where low vibration and low noise is an important issue.

What is claimed is:

1. A rolling bearing for use in a hard disk drive, wherein a surface roughness of a track surface of inner and outer races is made to be less than 18 nm Ra, and the inner and outer races are made of steel.

2. A rolling bearing according to claim 1, wherein the surface roughness of the track surface of the inner and outer races is made to be less than 10 nm Ra, and the inner and outer races are made of steel.

3. A rolling bearing according to claim 1, wherein the rolling bearing is used for a swing arm in the hard disk drive.

4. A rolling bearing according to claim 1, wherein the rolling bearing is used for a spindle motor in the hard disk drive.

5. A rolling bearing according to claim 1, wherein the steel is stainless steel.

6. A rolling bearing according to claim 2, wherein the steel is stainless steel.

7. A method for reducing rotation vibration in a hard disk drive comprising constructing a swing arm of the hard disk drive with the rolling bearing of claim 1.
